(19) United States
(12) Patent Application Publication
(10) Pub. No.: US 2026/0266660 A1
(43) Pub. Date: Sep. 10, 2026

(54) SPECTROMETER

(71) Applicant: OTO PHOTONICS INC., Hsinchu City (TW)

(72) Inventors: CHIEN-HSIANG HUNG, Hsinchu City (TW); HAO-PING WU, Hsinchu City (TW); MENG-CHIEH YANG, Hsinchu City (TW)

(73) Assignee: OTO PHOTONICS INC., Hsinchu City (TW)

(21) Appl. No.: 19/559,937

(22) Filed: Mar. 6, 2026

(30) Foreign Application Priority Data
Mar. 6, 2025 (TW) 114108372

(51) Int. Cl. G01J 3/28; G01J 3/02; G01J 3/18

(52) U.S. Cl. CPC G01J 3/2823; G01J 3/0208; G01J 3/021; G01J 3/0218; G01J 3/024; G01J 3/0291; G01J 3/1804; G01J 2003/1842

(57) ABSTRACT

A spectrometer includes a light input element, a collimator, a grating, a focusing module, an optical sensor and a plano-convex lens. The light input element with a slit height receives a light to be measured. The collimator collimates and limits the light via a vertical angle. The grating splits the light. A first vertical diopter of the focusing module is smaller than a first horizontal diopter thereof so that the light is emitted via a first perpendicular focusing angle. The optical sensor has a sensing height smaller than the slit height. The light is emitted to the optical sensor via a second perpendicular focusing angle from the plano-convex lens. A ratio of the vertical angle to the second perpendicular focusing angle is less than or equal to a ratio of the sensing height to the slit height.

### CROSS REFERENCE TO RELATED APPLICATIONS

The present invention claims benefit of Taiwan Application No. 114108372, filed in Taiwan Intellectual Property Office on Mar. 6, 2025, the disclosure of which is incorporated by reference herein.

### BACKGROUND OF THE INVENTION

### Field of the Invention

The present invention is related to an optical measuring device, and more particularly to a spectrometer.

### Description of Related Art

A spectrometer is a scientific instrument that applies optical principles to decompose light with complex components into spectral lights. Spectrometers can be used to observe, analyze, and process structures and compositions of substances, and have advantages including high analytical precision, a wide measurement range, a fast speed and a small sample usage, etc. Therefore, tasks, such as molecular characteristics distinguishing, concentration measurement, substance identification, spectrum measurement on astronomical objects, etc., require assistance of a spectrometer. In addition, spectrometers are widely used in various fields, including metallurgy, geology, petrochemicals, medicine and health, environmental protection, resources and hydrological surveying, etc.

However, in conventional spectrometers, a pixel height of a sensor thereof is lower than a slit height of its input device. Therefore, how to couple a sensor having a short height with a higher slit becomes an important problem and challenge.

### BRIEF SUMMARY OF THE INVENTION

The present invention is related to a spectrometer. The spectrometer can enhance coupling efficiency of optical sensors.

The present invention provides a spectrometer. The spectrometer includes a light input element, a collimator, a grating, a focusing module, an optical sensor and a plano-convex lens. The light input element has a slit height and is used to receive and output a light to be measured. The collimator is used to receive the light to be measured from the light input element and to collimate the light to be measured in order to restrict the light to be measured via a vertical angle. The grating is used to receive the light to be measured after being collimated from the collimating lens and to split the light to be measured. The focusing module is used to receive the light to be measured after being split from the grating, and to proceed vertical and horizontal focusing on the light to be measured. The focusing module has a first vertical diopter and a first horizontal diopter. The first vertical diopter is less than the first horizontal diopter, and the light to be measured is emergent out of the focusing module via a first perpendicular focusing angle. The optical sensor is disposed on a horizontal imaging plane of the focusing module. The optical sensor has a sensing height, and the sensing height is less than the slit height. The plano-convex lens is assembled with the optical sensor, and is disposed between the focusing module and the optical sensor. The plano-convex lens has a second vertical diopter with a positive value so that the light to be measured is emergent out of the plano-convex lens toward the optical sensor via a second perpendicular focusing angle. A ratio of the vertical angle to the second perpendicular focusing angle is less than or equal to a ratio of the sensing height to the slit height.

In a preferred embodiment of the present invention, the grating is a transmissive grating or a reflective grating.

In a preferred embodiment of the present invention, the collimator is a collimating lens, and the collimating lens and the focusing module are rotationally symmetrical.

In a preferred embodiment of the present invention, the focusing module includes a focusing lens and a cylindrical concave lens. The focusing lens is used to receive the light to be measured after being split from the grating and to focus the light to be measured. The cylindrical concave lens is used to receive the light to be measured after being focused from the focusing lens, and to vertically defocus the light to be measured so as to output the light to be measured after being vertically defocused toward the plano-convex lens.

In a preferred embodiment of the present invention, the cylindrical concave lens is a plano-concave lens. A planar surface of the cylindrical concave lens faces the focusing lens, and the planar surface of the cylindrical concave lens is used as a positioning surface in order to assemble the cylindrical concave lens with the focusing lens as a lens assembly.

In a preferred embodiment of the present invention, a planar surface of the plano-convex lens faces the optical sensor, and the planar surface of the plano-convex lens is used as a positioning surface in order to assemble the plano-convex lens with the optical sensor together.

In a preferred embodiment of the present invention, the plano-convex lens is a cylindrical convex lens, a radius of curvature of the cylindrical convex lens is smaller than a radius of curvature of the cylindrical concave lens.

In a preferred embodiment of the present invention, the focusing module includes a cylindrical concave lens and a focusing lens. The cylindrical concave lens is used to receive the light to be measured after being split from the grating, and to vertically defocus the light to be measured. The focusing lens is used to receive the light to be measured after being vertically defocused from the cylindrical concave lens, and to focus the light to be measured so as to output the light to be measured after being focused toward the plano-convex lens.

In a preferred embodiment of the present invention, the focusing module includes a focusing reflecting cylindrical mirror. The focusing reflecting cylindrical mirror is used to receive the light to be measured after being split from the grating, and to horizontally focus the light to be measured so as to output the light to be measured after being horizontally focused toward the plano-convex lens.

In a preferred embodiment of the present invention, the collimator is a collimating spherical mirror, a collimating cylindrical mirror, or a collimating toroidal mirror.

In a preferred embodiment of the invention, the spectrometer further includes an optical fiber. The optical fiber has a plurality of sub-fibers. The plurality of sub-fibers are arranged in a quasi-circular shape at a first end of the optical fiber, and are arranged in a strip shape at a second end of the optical fiber. The second end of the optical fiber is optically connected with the light input element. The plurality of sub-fibers are arranged in a strip array and aligned to match the slit height.

In a preferred embodiment of the present invention, the focusing module includes a focusing toroidal mirror. The focusing toroidal mirror is used to receive the light to be measured after being split from the grating, and to focus the light to be measured so as to output the light to be measured after being focused toward the plano-convex lens.

In a preferred embodiment of the present invention, the plano-convex lens is a cylindrical convex lens, and the focusing toroidal mirror has a vertical focusing performance less than the cylindrical convex lens.

In a preferred embodiment of the present invention, the focusing toroidal mirror proceeds horizontal focusing and vertical focusing on the light to be measured.

In a preferred embodiment of the invention, the slit height is more than three times of the sensing height of the optical sensor.

In a preferred embodiment of the present invention, the slit height is a height of an image formed on a slit extension plane of the light input element via reverse imaging toward the light input element based on an imaging height of the optical sensor.

Based on the above, the spectrometer of the above embodiments of the present invention can enlarge a focusing angle of the light to be measured entering the optical sensor in order to make coupling efficiency of the optical sensor higher through cooperation of the focusing module and the plano-convex lens.

The present invention is illustrated in details as follows according to specific embodiments accompanying attached drawings in order to much more easily understand purposes, technical contents, features and achieved effects of the present invention.

### BRIEF DESCRIPTION OF THE DRAWINGS

FIG. 1 shows a schematic top-side view of a spectrometer in accordance with a first preferred embodiment of the present invention.

FIG. 2A shows a schematic lateral view of the spectrometer of FIG. 1.

FIG. 2B shows a schematic imaging diagram of the spectrometer of FIG. 1.

FIG. 3 shows a schematic lateral view of a spectrometer in accordance with a second preferred embodiment of the present invention.

FIG. 4 shows a schematic lateral view of a spectrometer in accordance with a third preferred embodiment of the present invention.

FIG. 5 shows schematic top-side view of a spectrometer in accordance with a fourth preferred embodiment of the present invention.

FIG. 6 shows a schematic perspective view of an optical fiber used to transmit a light to be measured in accordance with the present invention.

FIG. 7 shows a schematic lateral view of the spectrometer of FIG. 5.

FIG. 8 shows a schematic lateral view of a spectrometer in accordance with a fifth preferred embodiment of the present invention.

### DETAILED DESCRIPTION OF THE INVENTION

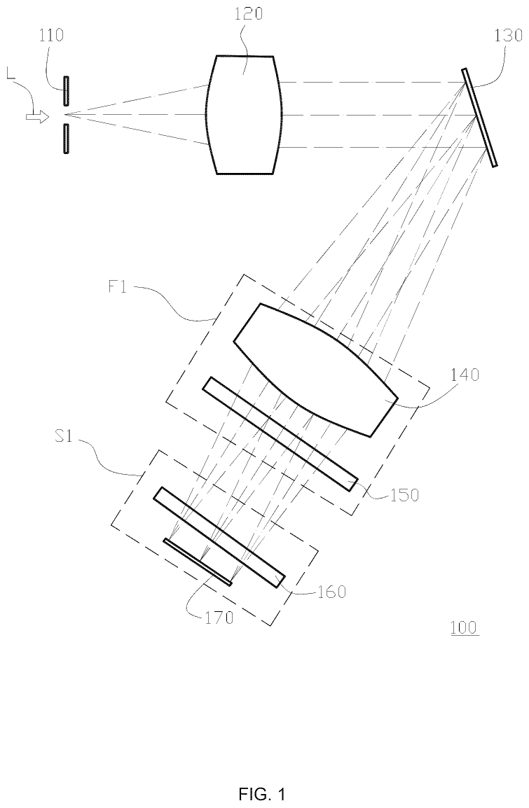

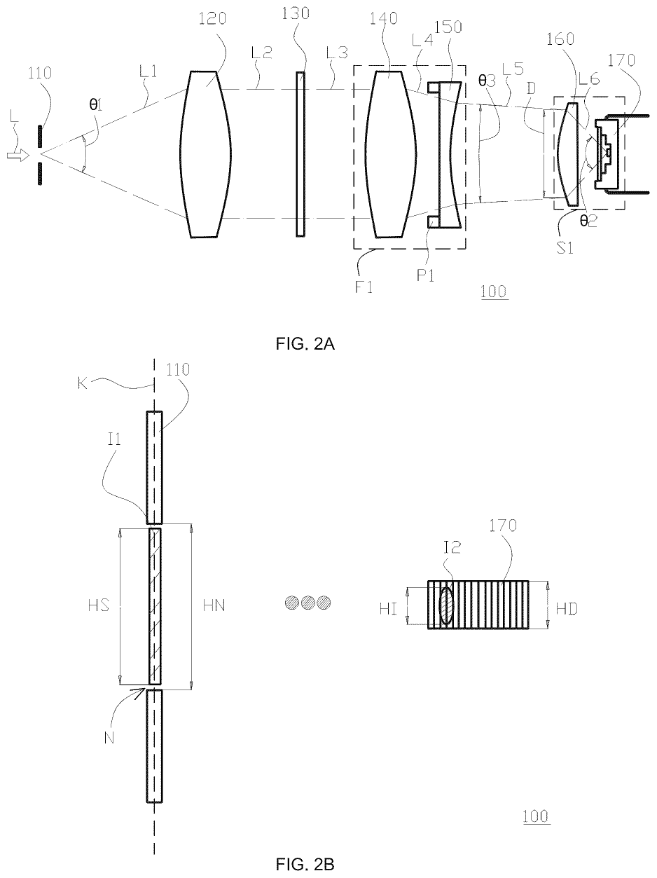

FIG. 1 shows a schematic top-side view of a spectrometer 100 in accordance with a first preferred embodiment of the present invention. FIG. 2A shows a schematic lateral view of the spectrometer 100 of FIG. 1. FIG. 2B shows a schematic imaging diagram of the spectrometer 100 of FIG. 1. Please refer to FIGS. 1, 2A, and 2B, the spectrometer 100 includes a light input element 110, a collimating lens 120 as a collimator, a grating 130, a focusing lens 140, a cylindrical concave lens 150, a cylindrical convex lens 160 and an optical sensor 170 arranged sequentially. For convenient reference, only the light input element 110 and the optical sensor 170 are shown in FIG. 2B, and other optical elements are omitted. The light input element 110 is, for example, a slit with a slit height HS. Generally, the slit height HS is a height of an image I1 formed on a slit extension plane K of the light input element 110 via reverse imaging toward the light input element 110 based on an imaging height H1 of the optical sensor 170. In other words, the slit height HS can be an effective slit height reversely derived from the imaging height HI. In the first preferred embodiment, the effective slit height HS is, for example, less than an actual opening height HIN of a slit opening N of the light input element 110 so that light L can be collected entirely. However, depending on different requirements, in another embodiment not shown in figures, the effective slit height HS reversely derived based on the imaging height HI can also be greater than or equal to the actual opening height HN.

Furthermore, the light input element 110 having the slit height HS can be sufficient to output light L1 to be measured. Assuming the collimating lens 120 has a vertical diopter D1 and a vertical effective focal length FL1, the vertical diopter D1 is a reciprocal of the vertical effective focal length FL1, i.e., D1=1/FL1. The collimating lens 120 is used to receive the light L1 to be measured from the light input element 110 and to collimate the light L1 to be measured in order for outputting a light L2 to be measured after being collimated. In the first preferred embodiment, the collimating lens 120 restricts the light L1 to be measured via a vertical angle θ1. In other words, the light L1 to be measured incident to the collimating lens 120 has the vertical angle θ1. The grating 130 is used to receive the light L2 to be measured from the collimating lens 120 after being collimated and to split the light L2 to be measured in order for outputting the light L3 to be measured after being split. In the first preferred embodiment, the grating 130 is exemplified as a reflective grating, but in another embodiment not shown in figures, the grating 130 may also be a transmissive grating, and is not limited thereto.

The focusing lens 140 is used to receive the light L3 to be measured after being split from the grating 130 and to further focus the light L3 to be measured so as to output the light L4 to be measured after being focused. In the first preferred embodiment, the collimating lens 120 may be rotationally symmetrical with the focusing lens 140. In details, the collimating lens 120 may be rotationally symmetric relative to the focusing lens 140 with respect to an optical axis. Furthermore, the collimating lens 120 and the focusing lens 140 may both be rotationally symmetric. The cylindrical concave lens 150 is used to receive the light L4 to be measured after being focused, and to vertically defocus the light L4 to be measured so as to output the light L5 to be measured after being vertically defocused. In the first preferred embodiment, the focusing lens 140 and the cylindrical concave lens 150 may form a lens group together as a focusing module F1. The focusing module F1 may be made so as to allow vertical focusing thereof being different from horizontal focusing thereof based on requirements. For example, assuming the focusing module F1 has a first vertical diopter VD1, a first vertical effective focal length VFL1, a first horizontal diopter HD1 and a first horizontal effective focal length HFL1, the first vertical diopter VD1 is less than the first horizontal diopter HD1 (i.e., VD1<HD1), and the first vertical effective focal length VFL1 is greater than the first horizontal effective focal length HFL1 (i.e., VFL1>HFL1). As a result, the light L5 to be measured is emergent out of the focusing module F1 via a first perpendicular focusing angle θ3 and a horizontal focusing angle. Particularly, the first perpendicular focusing angle is less than the horizontal focusing angle. In addition, a base (not shown) of the spectrometer 100 may have at least one positioning block P1 disposed between the focusing lens 140 and the cylindrical concave lens 150. The cylindrical concave lens 150 may be a plano-concave lens with a planar surface thereof facing the focusing lens 140. The planar surface of the plano-concave lens is also used as a positioning surface to abut against the at least one positioning block P1 for proceeding installation and positioning. Based on the above, a distance between the focusing lens 140 and the cylindrical concave lens 150 can be determined during installation, and the installation process is rather convenient and precise. The cylindrical convex lens 160 is a plano-convex lens with a planar surface thereof facing and being assembled with the optical sensor 170 to form a sensor module S1 together. The cylindrical convex lens 160 is disposed between the focusing module F1 and the optical sensor 170. The cylindrical convex lens 160 has a second vertical diopter VD2 with a positive value and a second vertical effective focal length of VFL2. The cylindrical convex lens 160 is used to receive the light L5 to be measured after being vertically defocused and to vertically focus the light L5 to be measured so that the light L6 to be measured after being vertically focused is emergent out of the cylindrical convex lens 160 toward the optical sensor 170 via a second perpendicular focusing angle θ2. In the first preferred embodiment, a radius of curvature of the cylindrical convex lens 160 can be smaller than a radius of curvature of the cylindrical concave lens 150.

The optical sensor 170 is disposed on a horizontal imaging plane of the focusing module F1 to receive and sense the light L6 to be measured after being vertically focused. In FIG. 2B, the spectrometer 100 has a vertical magnifying power M. The optical sensor 170 is, for example, a linear sensor with a sensing height HD. An image 12 imaged on the optical sensor 170 has an imaging height HI, where HI=M*HS. The sensing height HD is less than the slit height HS. In the first preferred embodiment, a space defined by the sensing height HD can be used to completely accommodate the image 12 imaged by the slit (i.e., the light input element 110). In other words, in the first preferred embodiment, the imaging height HI is less than or equal to the sensing height HD. However, under different requirements, the imaging height HI can also be greater than the sensing height HD. In other words, a size of the image 12 imaged on the optical sensor 170 is not limited by the first preferred embodiment as long as the image 12 can be imaged on the optical sensor 170. As shown in the following mathematical formula, the vertical magnifying power M is less than or equal to a ratio of the sensing height HD to the slit height HS.

$$M \leq \frac{HD}{HS}$$

Furthermore, the spectrometer 100 may have a vertical magnifying power M as expressed by the following mathematical formula, where FL1 is the vertical focal length of the collimating lens 120, VEFL2 is a vertical effective focal length generated by the focusing lens 140, the cylindrical concave lens 150 and the cylindrical convex lens 160, D1 is the vertical diopter of the collimating lens 120, and ED2 is a vertical effective diopter generated by the focusing lens 140, the cylindrical concave lens 150 and the cylindrical convex lens 160. As shown in the below mathematical formula, the vertical magnifying power M is equal to a ratio of the vertical effective focal length VEFL2 generated by the focusing lens 140, the cylindrical concave lens 150 and the cylindrical convex lens 160 to the vertical focal length FL1 of the collimating lens 120, and is further equal to a ratio of the vertical diopter D1 of the collimating lens 120 to the vertical effective diopter ED2 generated by the focusing lens 140, the cylindrical concave lens 150 and the cylindrical convex lens 160, and is also equal to a ratio of the vertical angle θ1 to the second perpendicular focusing angle θ2.

$$M = \frac{VEFL 2}{FL 1} = \frac{D 1}{ED 2} = \frac{θ1}{θ2}$$

Generally speaking, the vertical magnifying power M is a key factor for coupling efficiency of a sensor. The slit height HS multiplying by the vertical magnifying power M equals to the imaging height H1 of the slit. Since a sensing height HD of an ordinary sensor is lower than a corresponding slit height HS, the smaller the vertical magnifying power M is, the better high-extent coupling of the imaging height of a corresponding slit within a sensor having a short height the spectrometer 100 can perform. Therefore, the larger the second perpendicular focusing angle θ2 of the light L6 to be measured as shown in FIG. 2A is, the higher coupling efficiency of the optical sensor 170 the spectrometer 100 can achieve. It is worth mentioning that the cylindrical convex lens 160 is assembled together with the optical sensor 170 via a side of the cylindrical convex lens 160 with the planar surface. In addition to an advantage of easy assembly for the spectrometer 100, the second perpendicular focusing angle θ2 can be maintained as a large angle even though the cylindrical convex lens 160 and the optical sensor 170 are disposed within a close distance, and therefore the spectrometer 100 can have excellent coupling efficiency.

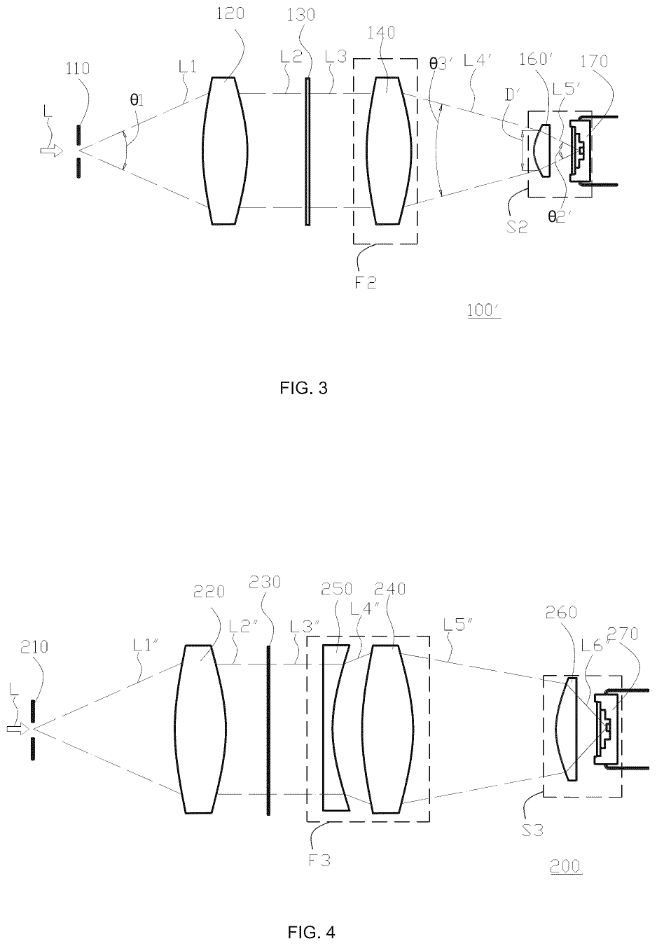

FIG. 3 shows a schematic lateral view of a spectrometer 100′ in accordance with a second preferred embodiment of the present invention. Please refer to FIGS. 2A and 3, the spectrometer 100′ shown in the second preferred embodiment is similar to the spectrometer 100 of the first preferred embodiment. In comparison with the spectrometer 100 of the first preferred embodiment, the spectrometer 100′ lacks the cylindrical concave lens 150 of the first preferred embodiment, and similar components are labeled with similar reference numerals and therefore will not be described again hereinafter. The cylindrical convex lens 160′ of the second preferred embodiment is used to receive the light L4′ to be measured after being focused by the focusing lens 140, and further vertically focus the light L4′ to be measured so as to output the light L5′ to be measured after being vertically focused. In the second preferred embodiment, the focusing lens 140 can alone constitute a focusing module F2. The optical sensor 170 is used to receive and sense the light L5′ to be measured after being vertically focused. In the second preferred embodiment, the cylindrical convex lens 160′ and the optical sensor 170 are assembled to form a sensor module S2. Considering the above factual descriptions for the first preferred embodiment, the smaller a vertical magnifying power M′ of the spectrometer 100′ intended to obtain for enhancing coupling efficiency is, the larger a perpendicular focusing angle θ2′ of the light L5′ to be measured traveling to the optical sensor 170 is required to be increased. Therefore, a second perpendicular focusing angle θ2′ of the light L5′ to be measured made via the focusing lens 140 can be larger than a first perpendicular focusing angle θ3′ of the light L4′ to be measured. As a result, the light L5′ to be measured is vertically focused on the optical sensor 170, and the vertical magnifying power M′ of the spectrometer 100′ is obtained from the vertical angle θ1 and the second perpendicular focusing angle θ2′. In addition, in comparison with the spectrometer 100′, the spectrometer 100 has additionally the cylindrical concave lens 150 disposed behind the focusing lens 140. The first perpendicular focusing angle θ3 of the light L5 to be measured shown in FIG. 2A can be larger than the first perpendicular focusing angle θ3′ of the light L4′ to be measured shown in FIG. 3. As a result, an effective aperture D of the light L5 to be measured entering the cylindrical concave lens 160 shown in FIG. 2A is larger than an effective aperture D′ of the light L4′ to be measured entering the cylindrical concave lens 160′ shown in FIG. 3. Therefore, in comparison with the second perpendicular focusing angle θ2′ of the optical sensor 170 of the spectrometer 100′ shown in FIG. 3, the optical sensor 170 of spectrometer 100 obtains the second longitudinal focusing angle θ2 being larger in order for reducing the vertical magnifying power M. In other words, in comparison with the vertical magnifying power M′ of spectrometer 100′, the vertical magnifying power M of spectrometer 100 is smaller, and coupling efficiency of the spectrometer 100 is higher.

FIG. 4 shows a schematic lateral view of a spectrometer 200 in accordance with a third preferred embodiment of the present invention. Please refer to FIGS. 2A and 4, the spectrometer 200 shown in the third preferred embodiment is similar to the spectrometer 100 of the first preferred embodiment, and only an order of component arrangement differs from each other. Similar components are labeled with similar reference numerals and therefore will not be described again hereinafter. The spectrometer 200 includes a light input element 210, a collimating lens 220, a grating 230, a cylindrical concave lens 250, a focusing lens 240, a cylindrical convex lens 260 and an optical sensor 270. The light input element 210 is used to receive a light L to be measured. The collimating lens 220 is used to receive a light L1″ to be measured from the light input element 210 and to collimate the light L1″ to be measured. The grating 230 is used to receive the light L2″ to be measured from the collimating lens 220 after being collimated, and to split the light L2″ to be measured. The cylindrical concave lens 250 is used to receive the light L3″ to be measured from the grating 230 after being split, and to vertically defocus the light L3″ to be measured. The focusing lens 240 is used to receive the light L4″ to be measured from the cylindrical concave lens 250 after being vertically defocused, and to focus the light L4″ to be measured. The focusing lens 240 and the cylindrical concave lens 250 constitute a focusing module F3 together. The focusing module F3 has a first vertical diopter VD1″, a first vertical effective focal length VFL1″, a first horizontal diopter HD1″ and a first horizontal effective focal length HFL1″. The first vertical diopter VD1″ is less than the first horizontal diopter HD1″ (i.e., VD1″<HD1″). The cylindrical convex lens 260 is used to receive the light L5″ to be measured from the focusing lens 240 after being focused, and to vertically focus the light L5″ to be measured. The optical sensor 270 is used to receive the light L6″ to be measured from the cylindrical convex lens 260 after being vertically focused, and to sense the light L6″ to be measured. In third preferred embodiment, the cylindrical convex lens 260 and the optical sensor 270 are assembled to form a sensor module S3. Similarly, in comparison with the spectrometer 100′ shown in FIG. 3, the spectrometer 200 can also further reduce the vertical magnifying power M″ to make coupling efficiency of the spectrometer 200 higher.

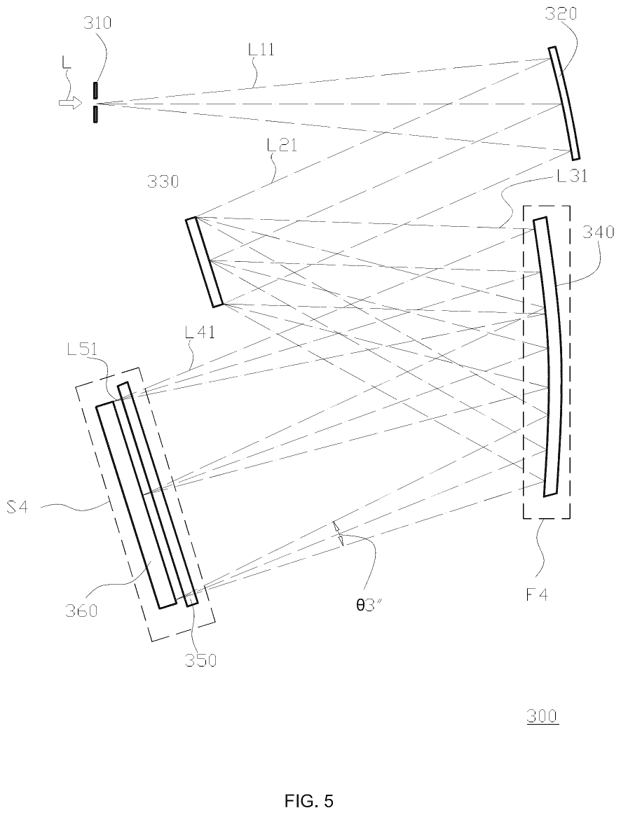

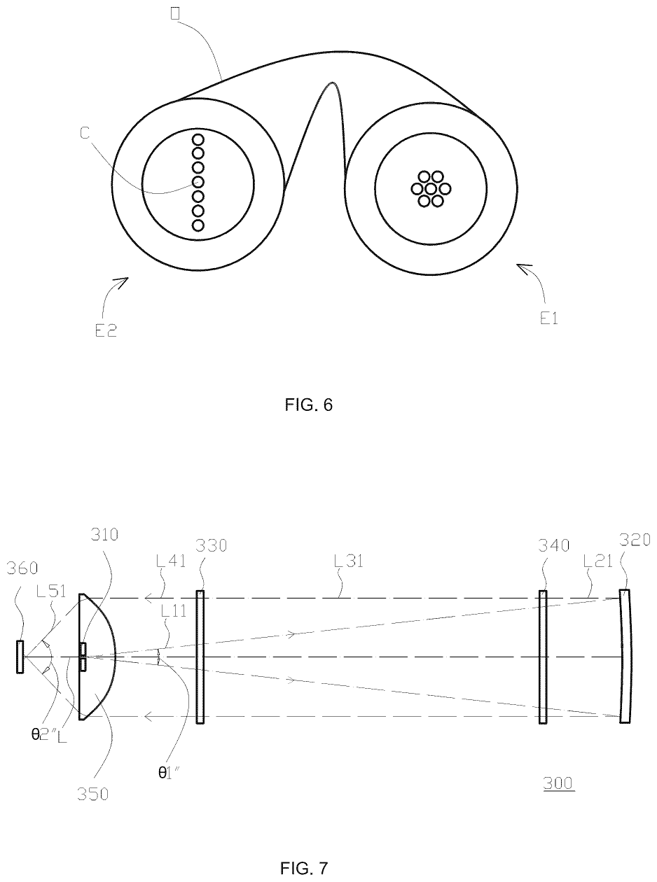

FIG. 5 shows schematic top-side view of a spectrometer 300 in accordance with a fourth preferred embodiment of the present invention. Please refer to FIGS. 1 and 5, the spectrometer 300 of the fourth preferred embodiment is similar to the spectrometer 100 of the first preferred embodiment, and similar components are labeled with similar reference numerals and therefore will not be described again hereinafter. Considering a main difference therebetween in an optical path, the collimating lens 120 is adopted in the spectrometer 100 of the first preferred embodiment while a reflective collimator 320 is adopted in the spectrometer 300 of the fourth preferred embodiment. Changes to another optical design are also made. In details, the spectrometer 300 includes a light input element 310, a collimator 320, a grating 330, a focusing module F4, an optical sensor 360 and a plano-convex lens 350. The light input element 310 having a slit height is used to receive a light L to be measured. FIG. 6 shows a schematic perspective view of an optical fiber used to transmit a light to be measured in accordance with the present invention. Please refer to FIGS. 5 and 6, in the fourth preferred embodiment, the spectrometer 300 may further include an optical fiber O to transmit the light L to be measured to the light input element 310. The optical fiber O has a plurality of sub-fibers C. The plurality of sub-fibers C may, for example, be designed to match circle, ellipse or regular polygonal beam profiles so that the plurality of sub-fibers C are arranged in a quasi-circular shape at a first end E1 of the optical fiber O, and the plurality of sub-fibers C are arranged in a strip shape at a second end E2 of the optical fiber O. The optical fiber O is optically connected with the light input element 310, for example, via the second end E2 of the optical fiber O. The plurality of sub-fibers C are arranged in a strip array and aligned to match the slit height.

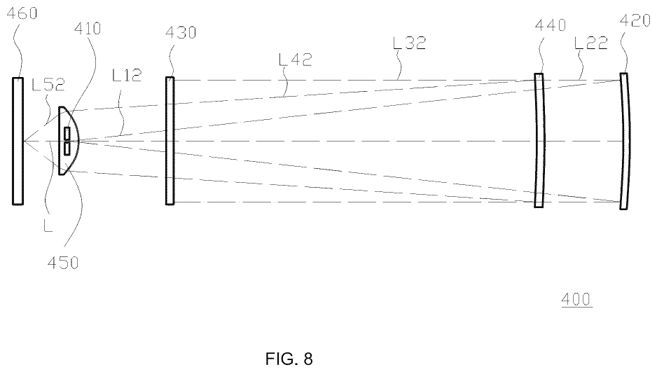

FIG. 7 shows a schematic lateral view of the spectrometer of FIG. 5. Please refer to FIGS. 5 and 7, a collimator 320 is used to receive and collimate the light L11 to be measured, and to restrict the light to be measured via a vertical angle θ1″. In the fourth preferred embodiment, the collimator 320 is, for example, a collimating spherical mirror. In another embodiment not shown in figures, the collimator 320 may also be a collimating cylindrical mirror or a collimating toroidal mirror in order to receive and horizontally collimate the light L11 to be measured. The grating 330 is, for example, a reflective grating, and is used to receive the light L21 to be measured after being collimated from the collimator 320 and to split the light L21 to be measured. The focusing module F4 is used to receive the light L31 to be measured after being split from the grating 330, and to vertically and horizontally focus the light L31 to be measured. The focusing module F4 has a first vertical diopter and a first horizontal diopter, and the first vertical diopter is less than the first horizontal diopter so that the light L31 to be measured is emergent out of the focusing module F4 via a first perpendicular focusing angle θ3″. The focusing module F4 may include a focusing cylindrical mirror 340. The focusing cylindrical mirror 340 is used to receive the light L21 to be measured after being split from the grating 330, and to horizontally focus the light L31 to be measured so that the light L41 to be measured is emergent out of the focusing cylindrical mirror 340 toward a plano-convex lens 350 via the first perpendicular focusing angle θ3″. In another embodiment not shown in figures, the focusing reflecting cylindrical mirror 340 can also be replaced by a focusing toroidal mirror to proceed horizontally and longitudinally focusing on the light L31 to be measured.

An optical sensor 360 is disposed on a horizontal imaging plane of the focusing module F4 and has a sensing height smaller than the slit height. The plano-convex lens 350 is assembled with the optical sensor 360 to form a sensor module S4, and the plano-convex lens 350 is disposed between the focusing module F4 and the optical sensor 360. The plano-convex lens 350 has a second vertical diopter with a positive value so that the light L51 to be measured is emergent out of the plano-convex lens 350 toward the optical sensor 360 via a second perpendicular focusing angle θ2″. A ratio of the vertical angle θ1″ to the second perpendicular focusing angle θ2″ is less than or equal to a ratio of the sensing height to the slit height. For example, the slit height can be 2300 μm, the sensing height can be 500 μm, and the ratio thereof is 4.6.

FIG. 8 shows a schematic lateral view of a spectrometer 400 in accordance with a fifth preferred embodiment of the present invention. Please refer to FIGS. 7 and 8, the spectrometer 400 of the fifth preferred embodiment is similar to the spectrometer 300 of the fourth preferred embodiment, and similar components are labeled with similar reference numerals and therefore will not be described again hereinafter. The spectrometer 400 includes a light input element 410, a collimator 420, a grating 430, a focusing toroidal mirror 440, an optical sensor 460 and a plano-convex lens 450. The collimator 420 may be a collimating spherical mirror used to receive and collimate the light L12 to be measured. The grating 430, for example, is a reflective grating, and is used to receive the light L22 to be measured after being collimated from the collimator 420 and to split the light L22 to be measured so that the light L32 to be measured is emergent out of the grating 430 to the focusing toroidal mirror 440. The focusing toroidal mirror 440 has a first vertical diopter and a first horizontal diopter, and the first vertical diopter is less than the first horizontal diopter. The focusing toroidal mirror 440 is used to receive the light L32 to be measured after being split from the grating 430, and to focus the light L32 to be measured so that the light L42 to be measured is emergent out of the focusing toroidal mirror 440 toward the plano-convex lens 450. The plano-convex lens 450 has a second vertical diopter with a positive value so that the light L52 to be measured is emergent out of the plano-convex lens 450 toward the optical sensor 460. In fifth preferred embodiment, the plano-convex lens 450 is a cylindrical convex lens. The focusing toroidal mirror 440 has a vertical focusing performance less than the cylindrical convex lens, i.e., the plano-convex lens 450, but is not limited thereto.

In summary, the spectrometers described in the above preferred embodiments can enlarge a focusing angle of the light to be measured entering the optical sensor in order to make coupling efficiency of the optical sensor higher.

The embodiments in accordance with the present invention described above are merely used to illustrate technical concepts and features of the present invention. The above descriptions are intended to enable those skilled in the art to understand contents of the present invention and to implement the present invention accordingly. The above descriptions should not be construed as limiting the claimed scope of the present invention. In other words, all equivalent variations or modifications made in accordance with the inventive spirit disclosed above for the present invention should still be covered within the claimed scope of the present invention.

What is claimed is:

1. A spectrometer, comprising:
a light input element comprising a slit height, and being used to receive and output a light to be measured;
a collimator used to receive the light to be measured from the light input element and to collimate the light to be measured in order to restrict the light to be measured via a vertical angle;
a grating used to receive the light to be measured after being collimated from the collimating lens and to split the light to be measured;
a focusing module used to receive the light to be measured after being split from the grating, and to proceed vertical and horizontal focusing on the light to be measured, wherein the focusing module has a first vertical diopter and a first horizontal diopter, the first vertical diopter is less than the first horizontal diopter, the light to be measured is emergent out of the focusing module via a first perpendicular focusing angle;
an optical sensor disposed on a horizontal imaging plane of the focusing module, the optical sensor having a sensing height, and the sensing height being less than the slit height; and
a plano-convex lens being assembled with the optical sensor, and being disposed between the focusing module and the optical sensor, wherein the plano-convex lens has a second vertical diopter with a positive value so that the light to be measured is emergent out of the plano-convex lens toward the optical sensor via a second perpendicular focusing angle, a ratio of the vertical angle to the second perpendicular focusing angle is less than or equal to a ratio of the sensing height to the slit height.

2. The spectrometer as claimed in claim 1, wherein the grating is a transmissive grating or a reflective grating.

3. The spectrometer as claimed in claim 1, wherein the collimator is a collimating lens, the collimating lens is rotationally symmetrical with the focusing lens.

4. The spectrometer as claimed in claim 1, wherein the focusing module comprises:
a focusing lens used to receive the light to be measured after being split from the grating and to focus the light to be measured; and
a cylindrical concave lens used to receive the light to be measured after being focused from the focusing lens, and to vertically defocus the light to be measured so as to output the light to be measured after being vertically defocused toward the plano-convex lens.

5. The spectrometer as claimed in claim 4, wherein the cylindrical concave lens is a plano-concave lens, a planar surface of the cylindrical concave lens faces the focusing lens, the planar surface of the cylindrical concave lens is used as a positioning surface in order to assemble the cylindrical concave lens with the focusing lens as a lens assembly.

6. The spectrometer as claimed in claim 1, wherein a planar surface of the plano-convex lens faces the optical sensor, the planar surface of the plano-convex lens is used as a positioning surface in order to assemble the plano-convex lens with the optical sensor together.

7. The spectrometer as claimed in claim 1, wherein the plano-convex lens is a cylindrical convex lens, a radius of curvature of the cylindrical convex lens is smaller than a radius of curvature of the cylindrical concave lens.

8. The spectrometer as claimed in claim 1, wherein the focusing module comprises:
a cylindrical concave lens used to receive the light to be measured after being split from the grating, and to vertically defocus the light to be measured; and
a focusing lens used to receive the light to be measured after being vertically defocused from the cylindrical concave lens and to focus the light to be measured so as to output the light to be measured after being focused toward the plano-convex lens.

9. The spectrometer as claimed in claim 1, wherein the focusing module comprises:
a focusing reflecting cylindrical mirror is used to receive the light to be measured after being split from the grating, and to horizontally focus the light to be measured so as to output the light to be measured after being horizontally focused toward the plano-convex lens.

10. The spectrometer as claimed in claim 1, wherein the collimator is a collimating spherical mirror, a collimating cylindrical mirror or a collimating toroidal mirror.

11. The spectrometer as claimed in claim 1, further comprising:
an optical fiber comprising a plurality of sub-fibers, wherein the plurality of sub-fibers are arranged in a quasi-circular shape at a first end of the optical fiber, and are arranged in a strip shape at a second end of the optical fiber, the second end of the optical fiber is optically connected with the light input element, the plurality of sub-fibers are arranged in a strip array and aligned to match the slit height.

12. The spectrometer as claimed in claim 1, wherein the focusing module comprises:
a focusing toroidal mirror used to receive the light to be measured after being split from the grating, and to focus the light to be measured so as to output the light to be measured after being focused toward the plano-convex lens.

13. The spectrometer as claimed in claim 12, wherein the plano-convex lens is a cylindrical convex lens, the focusing toroidal mirror has a vertical focusing performance less than the cylindrical convex lens.

14. The spectrometer as claimed in claim 12, wherein the focusing toroidal mirror proceeds horizontal focusing and vertical focusing on the light to be measured.

15. The spectrometer as claimed in claim 1, wherein the slit height is more than three times of the sensing height of the optical sensor.

16. The spectrometer as claimed in claim 1, wherein the slit height is a height of an image formed on a slit extension plane of the light input element via reverse imaging toward the light input element based on an imaging height of the optical sensor.
